(19) United States
(12) Patent Application Publication
(10) Pub. No.: US 2003/0049438 A1
(43) Pub. Date: Mar. 13, 2003

(54) Adhesive containing amides and magnesium silicate

(75) Inventors: David Hillis Hawes, Clifton Forge, VA (US); Ralph Scott Peterson, Clifton forge, VA (US); Mohan Sasthav, Elkridge, MD (US)

Correspondence Address: Donald L. Bowman , Esq., Westvaco Corporation - Law Dept., Mill Rd. - Research, Covington, VA, 24426, US

(73) Assignee: Westvaco Corporation

(21) Appl. No.: 09/950,616

(22) Filed: Sep. 13, 2001

(51) Int. Cl. B32B 7/12; B32B 15/04

(52) U.S. Cl. 428/343; 428/354; 428/346

(57) ABSTRACT

The invention relates to an adhesive for securing PCTFE films, especially blister containers to a support structure such as paperboard. In an exemplary embodiment an adhesive hot melt is blended with amides, such as erucamide, and minerals, such as magnesium silicate. The adhesive blend is mixed with optimal mixtures of amides and magnesium silicate. The adhesive blend is extruded onto a support structure such as paperboard.

### BACKROUND OF THE INVENTION

This invention relates to an adhesive containing amides and magnesium silicates, that is especially useful to secure polychlorotrifluoroethylene (PCTFE) film to a paperboard laminate to form a blister package.

As illustrated in FIGS. 1-3, a blister package 300 (FIG. 3) is conventionally formed by securing a blister container 100 (FIG. 1) to a support structure 200 (FIG. 2) to form a blister package 300 (FIG. 3). Conventional blister containers 100 are formed from a clear, moldable material 110 such as PCTFE or polyvinyl chloride (PVC). An exemplary PCTFE blister material is Aclar®, produced by Allied Signal of Morristown, N.J. Typically, the blister container 100 is filled with a product 130 such as a pharmaceutical pill. After inserting the product 130, the blister container 100 may optionally be sealed with a backing 120, such as aluminum foil, plastic, or paper.

The blister container 100 with product 130 and optional backing 120 is typically secured by an adhesive to a support structure 200, such as a paperboard laminate. An exemplary conventional support structure 200 is a paperboard laminate consisting of a paperboard substrate coated with and an adhesive. An exemplary adhesive for use with paperboard laminates is ethylene vinyl acetate (EVA) adhesive. An exemplary paperboard laminate with an adhesive coating is PRINTKOTE Easy Seal Plus® produced by Westvaco Corporation, Stamford, Conn.

FIG. 2 illustrates a fold-over support structure 200 with a first part 210 and second part 220 secured to each other along a fold-line or perforation 230. The first part 210 has an optional perforation or feature 217 to assist with product 130 removal from the blister container 100 and optional backing 120. The second part 220 of support structure 200 typically has an aperture 225 to allow it to fold over the blister container 100 and secure to the first part 210.

As illustrated in FIG. 3 the blister container 100 is secured to the support structure 200. Typically an adhesive coating or layer is applied to either one or both surfaces of the support structure 200 or the blister container 100 or blister backing 120 or any combination thereof. There are numerous conventional extrudable adhesive resins, such as ethylene vinyl acetate (EVA), which will readily adhere to a blister container 100 such as a container formed from PVC. However only a limited number of adhesives will adhere to PCTFE films, such as Aclar® blisters. An exemplary adhesive for use with PCTFE films contains an EVA hot melt mixed with calcium carbonate and is disclosed in U.S. Pat. No. 6, 010, 784 issued to R. S. Peterson and assigned to Westvaco Corporation.

In one conventional blister package 300 fabrication method the blister container 100 is mounted on the first part 210 of the support structure 200. The second part 220 of the support structure 200 is then folded along perforation 230 and fitted over the blister container 100. The first part 210 and second part 220 of the support structure 200 are then typically pressed together to secure by adhesive means the blister container 100 between the first and second parts 210, 220 to form a completed blister package 300. It is conventionally know to form a plurality of blister packages 300. It is also known to secure a blister container 100 to a single part support structure 210 without a second part 220.

FIGS. 4 and 5 illustrate a conventional paperboard laminate 400, 500, such as Printkote® manufactured by Westvaco Corporation for use as a support structure 200 consists of at least two layers. The main layer is a paperboard substrate 410, 510 with a bottom surface 411, 511. FIG. 4 illustrates a substrate 410 with two coatings 415, 420. FIG. 5 illustrates a substrate 510 with one coating 520. The paperboard substrate 410, 510 is typically constructed from a 0.018 inch thick bleached sulfate sheet. Typically, the term paperboard refers to paper within a thickness range of approximately 0.008 to approximately 0.028 inches thick. The invention is relevant to this thickness range and beyond. In addition, the paperboard typically have one side coated, such as 411, 511 with for example clay or particulate minerals to provide a smooth printing surface.

As shown in FIG. 4, a paperboard substrate 410 often undergoes a conventional process called extrusion, wherein a extrusion coating 415 is applied to the paperboard substrate 410. The extrusion coating 415 is preferably an extrudable material that adheres well to a surface of the paperboard substrate 410 and any adhesive coating applied to the extrusion coating 415. A typical extrusion coating is a resin such as HL 9918X® manufactured by H.B. Fuller of St. Paul, Minn. A conventional extrusion coatings 415 comprise low density polyethylene (LDPE), but may also comprise linear low density polyethylene (LLDPE), high density polyethylene (HDPE), and copolymers of polyethylene (PE). The coat weight of the extrusion coating 415 is on the order of 5 to 10 pounds per ream (ream size 3,000 square feet) a 6 pound per ream coating is exemplary. It is also conventionally known to blend various copolymers with the extrusion coating 415.

As shown in FIGS. 4 and 5, an adhesive layer 420, 520, such as EVA based hot melt blend HL 9918X® or HL9936® manufactured by H.B. Fuller of St. Paul, Minn. in is coated to the paperboard laminate. The adhesive layer 420, 520 is typically coated to an extrusion coating 415 or directly to the paperboard substrate 510. The coat weight of the adhesive layer 420, 520 is in the range of approximately 4 pounds to approximately 7 pounds per ream with a coat weight of at least 5 pounds preferred.

One drawback to the conventional method is that soft and tacky adhesive layers 420, 520, such at EVA hot melt, when placed on a support structure 200 can cause converting problems during support structure 200 fabrication. An exemplary problem is difficulty in unwinding paperboard rolls especially when stored at high temperatures or high humidity. The EVA hot melt can also cause blocking of sheets stored as stacks on pallets at high temperatures or high humidity. Blocking is a phenomenon where one side, typically a polymer coated side of a paperboard sticks to the other side of the paperboard, typically a clay coated side, when the material is in either in roll form or sheet form.

A support structure with an EVA hot melt 420, 520 can have several other problems during the conversion process. Exemplary other problems include sheets of the support structure sticking to each other during sheet-fed printing and die-cutting; sheets sticking to the die-cutting plate; and picking or loosening any clay-coating on the support structure resulting in print hickeys.

It is known to secure PCTFE blister containers to paperboard laminates by blending calcium carbonate to EVA adhesive hot melt. Exemplary of such art is commonly assigned U.S. Pat. No. 6,010,784 to Ralph Scott Peterson entitled “Paperboard Laminate For Pharmaceutical Blister Packaging Using a Hot Melt Adhesive and Calcium Carbonate Blend” which is incorporated herein by reference The calcium carbonate is known to aid die-cutting and reduce blocking of the paperboard laminate coated with EVA adhesive hot melt. However calcium carbonate blends can phase separate and clog the extruder screen pack. Calcium carbonate can also form agglomerates instead of dispersing uniformly in an adhesive blend and the agglomerates can block an extrusion machine's flow channels. The Peterson patent does not fully solve the conversion and handling problems of paperboard laminates with EVA adhesive hot melt blocking at high temperature and humidity or print defects due to clay picking or sticking of sealant layer to die-cutting plate.

It is known that mineral additives added to polymer films during their manufacture help prevent blocking when the films are wound. A conventional mineral additive, magnesium silicate, commonly referred to as talc, is used as an anti-block agent used for these film applications, see E. J. Roger, “Antiblock, the Basics” 1998 TAPPI Polymer, Laminations and Coatings Conference. However, the interactions between adjacent layers in a roll of film are different from the interactions between the layers of hot melt coated paperboard. What is needed is an anti-block means for a clay coated side of a paperboard substrate to minimize blocking with the adhesive-coated sided of a paperboard substrate stacked on top of it.

There is also a need for an improved adhesive coating for paperboard laminate which can be used to secure blister containers, especially containers made from polychlorotrifluoroethylene films, to paperboard laminates. It is also desired to reduce conventional blocking problems for paperboard laminates at high temperatures and humidity. It is further desired to have a paperboard laminate with an improved adhesive coating that minimizes clay picking during printing and reduces sticking of the laminate to the counter plate during die-cutting.

### SUMMARY OF THE INVENTION

The invention relates to an adhesive for securing PCTFE films, especially blister containers to a support structure such as paperboard. In an exemplary embodiment an adhesive hot melt is blended with amides, such as erucamide, and minerals, such as magnesium silicate. The adhesive blend is mixed with optimal mixtures of amides and magnesium silicate. The adhesive blend is extruded onto a support structure such as paperboard.

### BRIEF DESCRIPTION OF THE DRAWING

The above and other features of the present invention which will become more apparent in the detailed description that follows, and can best be understood by the detailed description in conjunction with the accompanying figures, wherein like characters represent like parts throughout the several view and in which:

FIG. 1 is a prior art elevation view of a blister container with backing;

FIG. 2 is a prior art plan view of a fold-over support structure;

FIG. 3 is a prior art cross-sectional view of a blister package;

FIG. 4 is a prior art elevation view of a paperboard laminate support structure;

FIG. 5 is a prior art elevation view of another paperboard laminate structure;

FIG. 6 is a graphical illustration the blocking tendency of a paperboard laminate coated with an adhesive containing diatomaceous earth;

FIG. 7 is a graphical illustration of the fiber tear or heat sealing ability of a paperboard laminate coated with an adhesive containing diatomaceous earth;

FIG. 8 is a graphical illustration of blocking tendency of a paperboard laminate coated with an adhesive according to the invention; and

FIG. 9 is a graphical illustration of the fiber tear or heat sealing ability of a paperboard laminate coated with an adhesive according to the invention.

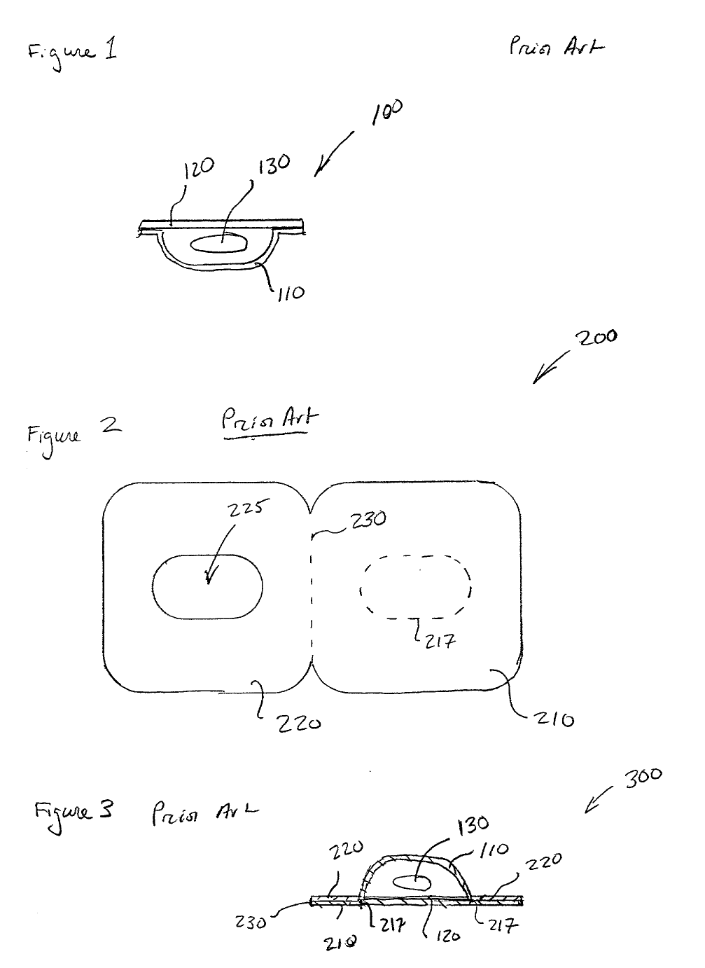

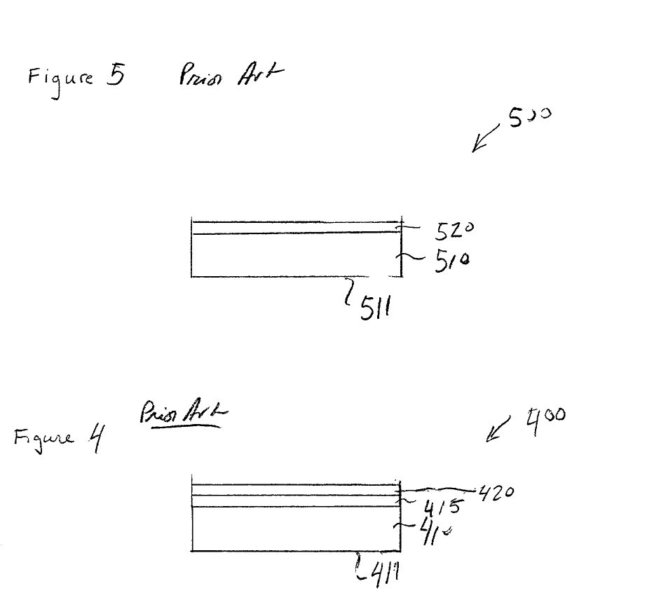

### DETAILED DESCRIPTION OF THE INVENTION

In order to measure the blocking tendency of various adhesive coatings secured to paperboard laminates, a series of test sample paperboard laminates with various adhesive mixtures were prepared. For each test a paperboard laminate was fabricated comprising a paperboard substrate with one side clay coated and the other side extrusion coated with a LDPE polymer layer. Various mixtures or blends of EVA based hot melt adhesive were extruded over the LDPE layer. The content of the EVA adhesive coating was altered for the various tests to provide a range of test data. The various samples were tested to measure the blocking tendencies of the various adhesive mixtures.

The adhesive coating is preferably applied to a paperboard substrate as an extrusion coating. Prior to extrusion, a base adhesive was blended with various concentrations of a masterbatch adhesive mixed with various combinations of anti-blocking agents and/or slipping agents. An exemplary base adhesive is ethylene vinyl acetate (EVA) based hot melt such as HL 99918-X or HL 9936, produced by HB Fller of St. Paul, Minn. However the adhesive may also comprise ethylene-methyl acrylate (EMA), ionomers (Surlyn) and acrylic copolymers. The coat weight of the adhesive coating with mixing agents is on the order of approximately 4 pounds to approximately 7 pounds per ream with an exemplary coat weight of approximately 5 pounds or higher. The invention is relevant to a full scope of paperboard substrates, polymers, and adhesive coatings.

A first masterbatch or mixing batch of adhesive was prepared with 25% diatomaceous earth and 75% EVA hot melt. A second masterbatch or mixing batch of adhesive was prepared with 50% magnesium silicate (talc) and 50% EVA hot melt. A third masterbatch of adhesive was prepared with an amide, e.g. Erucamide, with about 10% erucamide and 90% EVA hot melt. It is to be understood that the ranges of the masterbatch mixtures are exemplary and that the invention applies to a broad range of adhesives and masterbatch concentrations.

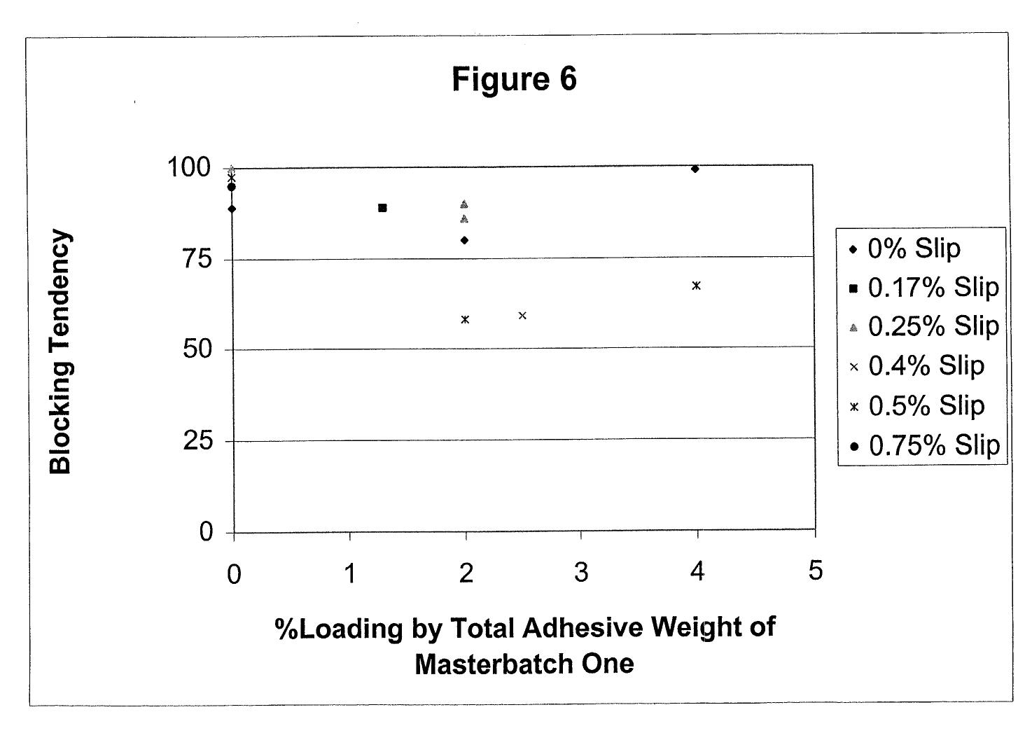

For testing purposes, the base adhesive was mixed with various concentrations of the three masterbatches. The blended adhesive was extruded onto a Printkote® paperboard substrate with one clay coated surface and tested for blocking and slip. FIGS. 6-9 graphically illustrate the blocking tendency and fiber tear for a wide range of adhesive mixture concentrations.

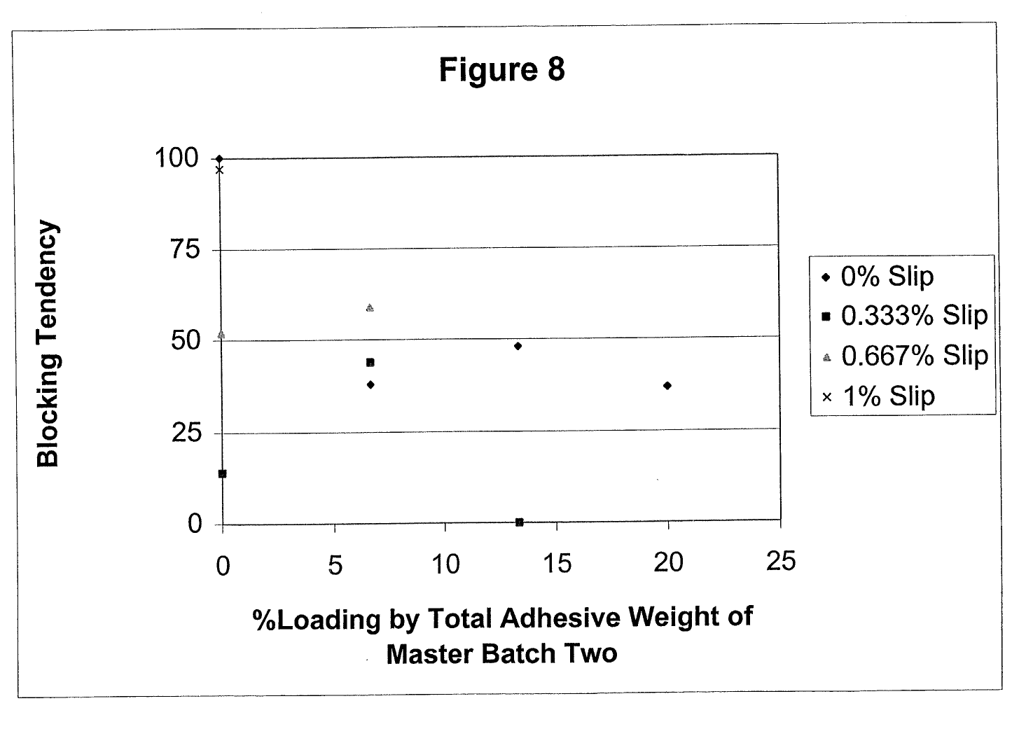

The samples blocking tendency was visually rated on a scale of 0 (no blocking) to 100 (severe blocking). For FIGS. 6 and 8 two identical paperboard samples were heated sealed to each. The adhesive coated side of one sample was sealed to a clay coated side of another sample at 200 F for 6 seconds and observing the bond between the two sides. The blocking tendencies of the two samples were visually graded across a spectrum of anti-blocking and slip agent concentrations.

The blocking tendency of the samples were also determined by placing five samples under 1 pound per square inch load in a humidity chamber at 100 F and 90% Relative Humidity (RH) for 24 hours. An additional five samples were evaluated under 1 pound per square inch load in a humidity chamber at 120 F and 75% RH for 24 hours. The samples were rated for blocking tendency subjectively on a visual scale of 1 (no blocking) to 5 (severe blocking).

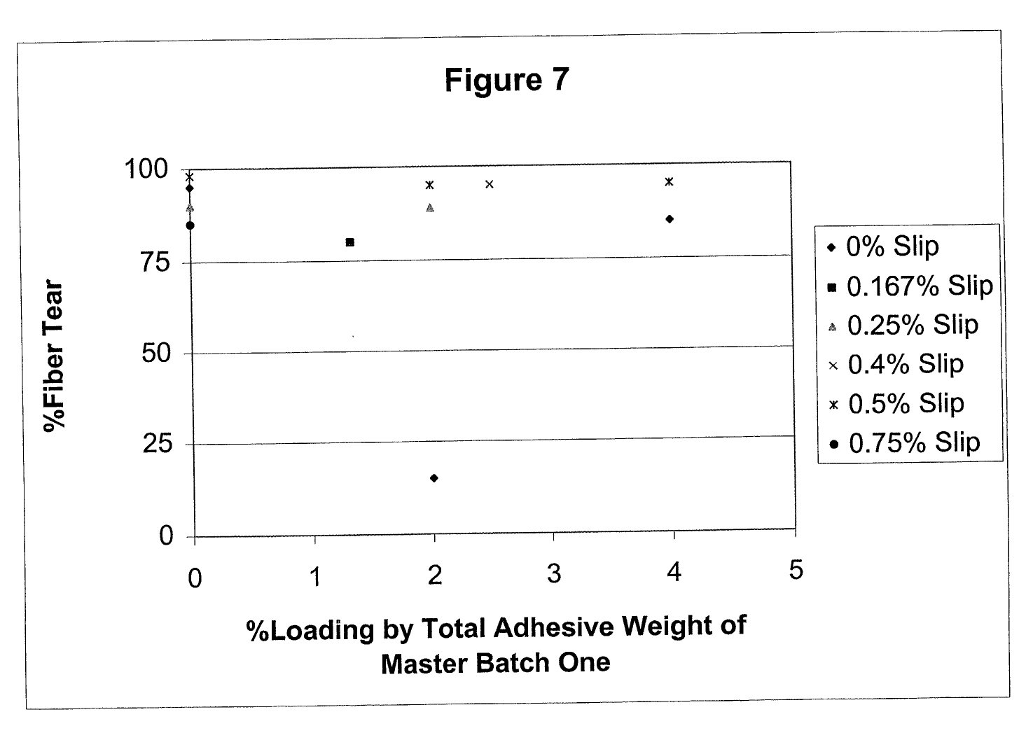

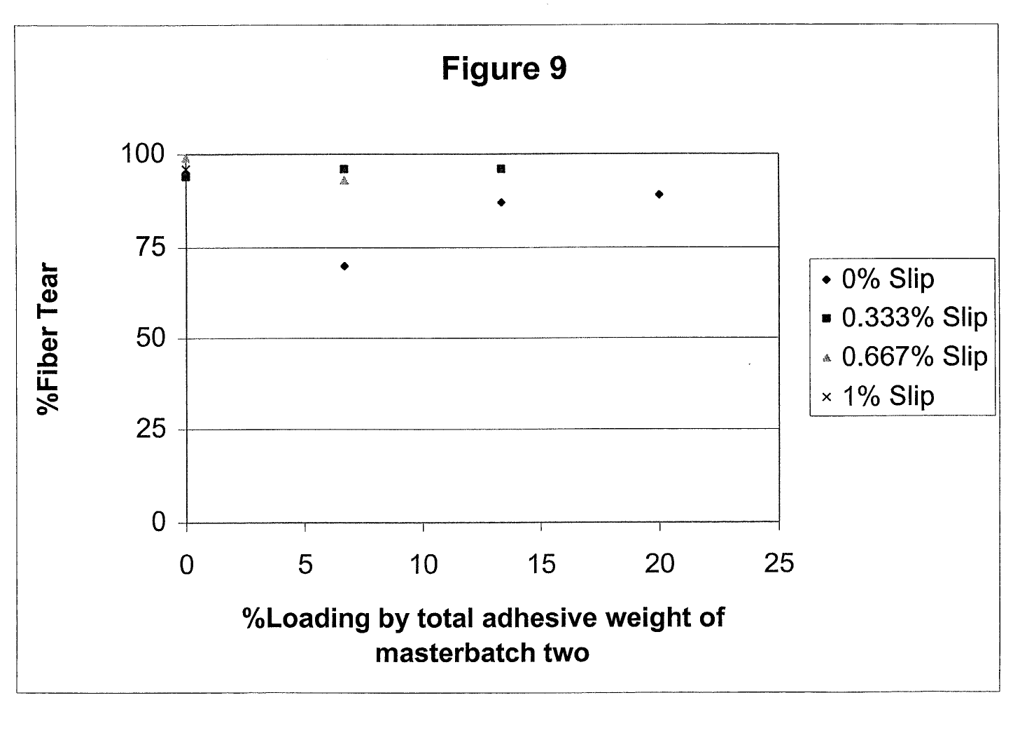

The samples were also tested for heat sealing ability between an Aclar® film and adhesive coatings with various concentrations of the three masterbatches. FIGS. 7 and 9 graphically illustrate the fiber tear of the samples. Heat sealing ability was rated on a scale of 0 (no seal) to 100 (excellent seal) as measured by a visual inspection of the percentage of fiber tear when the film was removed. Heat seal performance was determined by heating sealing a layer of paperboard laminate coated adhesives with various concentrations of the masterbatches to an Aclar® film blister at 325 F for six seconds. The degree of fiber tear bond between the Aclar® film and the paperboard laminate were observed. Based on the pooled variance of the experimental results, a 90% confidence interval was calculated for each set of test data.

FIG. 6 is a graphical illustration of the blocking tendency of various paperboard laminate samples. The base adhesive coating was loaded with between 0 and 4% of the first masterbatch and 0 to 1% of the third masterbatch by total adhesive coating weight. The graph shows that the addition of the first masterbatch (diatomaceous earth) to the base adhesive coating did not by itself significantly reduce blocking tendencies of the paperboard laminate samples. However as the third masterbatch (containing erucamide) was added to the adhesive coating in concentrations in the range of about 0.4% to about 0.75% of total adhesive coat by weight, the blocking tendency of the paperboard laminate samples were reduced.

FIG. 7 is a graphical illustration of the heat sealing ability of an EVA-coated paperboard laminate to Aclar® film across a range of masterbatch concentrations as described above. The graph illustrates that the samples previously identified as having good antiblocking properties (FIG. 6) demonstrate no significant heat sealing ability loss from the addition of anti-blocking agents (Diatomaceous Earth) to the adhesive coating. However at higher slip loading, i.e, when the third masterbatch is greater than 0.5% by total concentration of the total adhesive coating weight, the slip agent may transfer to the clay coated side of the paperboard substrate and affect printing.

FIG. 8 is graphical illustration of the blocking tendency of a paperboard laminate sample with an adhesive coating wherein the base adhesive coating was blended with between about 0% to about 20% of the total adhesive coating of the second masterbatch containing magnesium silicate (talc). A range of concentrations for the third masterbach varied from 0 to 1% in the base adhesive. The graph shows that the addition of the magnesium silicate (talc) to the base adhesive coating in concentrations greater than 5% reduced blocking tendencies substantially.

However as illustrated in FIG. 9, magnesium silicate without masterbatch 3 ( (slip additive) reduced heat sealing ability of the paperboard laminate sample to Aclar® film by 25%. A review of both FIGS. 8 and 9 show that performance in both blocking and heat sealing were optimized by addition of about 0.33% to 0.667% slip additive (masterbatch 3) and 0 to 6.5% talc (masterbatch 2) by weight to the adhesive coating.

Other samples and observations show that the addition of slip agents to a polymer coating on the paperboard substrate usually compromised the heat seal ability of the polymer coating, while the addition of the slip agent (amide) to an adhesive coating, such as EVA, did not adversely impact heat seal ability. Further experiments demonstrated that the use of an antiblock masterbatch such as Ampacet 501289® manufactured by Ampacet Corp. of Tarrytown, N.Y. containing 60% talc, 1.2% erucamide, and 38.8% EVA hot melt HL 9917X reduced blocking tendencies. The addition of 8 to 12% of this antiblock blend to HL 9918X® used as a base adhesive significantly reduced blocking and die cutting problems.

Further testing of the benefits of adding slip agents and anti-blocking agents to EVA adhesive coatings were conducted. A trial was set up to evaluate the effect of paperboard laminates with fatty acid amides on die-cutting. A 12.5% antiblock concentrate, Ampacet 501289®, was added to a base adhesive (hot melt HL9918X) for a final formulation containing 7.5% talc, 0.15% erucamide slip, 4.85% HL 9917X and 87.5% HL 9918X (base adhesive). The die cutter used in the test had double-beveled knives (0.937 inches high and 42 degree angle) and medium density ejection rubber (⅜ inch high, 60 Shore A hardness). Paperboard sheets of 24 inch by 44 inch of 10 point Easy Seal Plus® containing the above antiblock formulation were successfully converted into blister cards on a Bobst die cutter. EasySeal Plus® paperboard with adhesive coating not containing anti-block agents did not undergo conversion successfully. The sheets lacking the anti-block stuck to the steel bottom plate and did not eject from the die-cutter.

In addition a chill roll station was changed from a Root Mean Square (RMS) of 40 to a RMS of 100 which slightly reduced blocking of Easy Seal Plus® containing an anti-block agent of 12.5% Ampacet 501289®. Additional testing was done by embossing the hot melt surface of Easy Seal Plus® with a smooth and rough finish to evaluate the effect of chill roll finish on blocking using a scale of 1 (no blocking) to 5 (severe blocking). The roughness of these samples was 28-34 for the smooth sample, 61-67 for the control sample, and 147-183 for the rough sample. The control sample was rated as 2-3, the smooth sample was rated 4 and the rough sample was rated 2. The test demonstrated that an adhesive coating with a 12.5% anti-block concentrate (Ampacet 501289®) chilled rolled with a roughness of 147 to 183 RMS further reduced blocking tendency compared to chill roll roughness of 28-67 RMS.

Finally further analysis was done on the sealant layer of Easy Seal Plus®. This board sometimes has a tendency to pick or loosen the clay coating from the adjacent sheet. The clay particles transfer onto the printing roll and result in print “hickeys” or “skips.” A series of experiments were run with a range of binder content in the clay. The results shown that higher binder content in the clay coating increases the surface strength of the clay coating and reduces printing problems.

Other slip additives such as stearamide and behenamide may also be used in combination with antiblock additives for adhesive-coated paperboard that act as an internal lubricate to the surface of the adhesive coating. It is to be understood that the above adhesive coating can incompass a wide range of amides, and silicates based products. The magnesium silicate based compounds are added to increase the roughness of the adhesive coating. It is to be understood that scope of the invention includes a wide range of antiblock additives that can increase the roughness of the adhesive coating without disrupting the extrusion process.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. An adhesive coating comprising hot melt adhesive, magnesium silicate and an amide.

2. The adhesive of claim 1, wherein said hot melt adhesive comprises EVA.

3. The adhesive of claim 1, wherein said amide comprises at least one of the following: erucamide, stearamide and behenamide.

4. The adhesive of claim 2, wherein the amide comprises less than about 1 percent of the total adhesive coat weight.

5. The adhesive of claim 1, wherein magnesium silicate comprises less than about 20 percent of the total adhesive coat weight.

6. A paperboard laminate comprising:
a paperboard substrate; and
an adhesive coating secured to said paperboard substrate, wherein said adhesive coating comprises hot melt adhesive, magnesium silicate and an amide.

7. A package comprising:
a paperboard laminate wherein said paperboard laminate comprises a paperboard substrate with an adhesive coating secured to said paperboard substrate, wherein said adhesive coating comprises hot melt adhesive, magnesium silicate and an amide; and
a blister film wherein at least one surface of said blister film is at least partially secured to said adhesive coating.

8. The package of claim 8, wherein said blister film comprises PCTFE.

9. The package of claim 7, wherein said blister film is formed into a container with an open side and a backing is secured to said open side and said backing is secured to said paperboard laminate.
